(19) United States
(12) Patent Application Publication
(10) Pub. No.: US 2012/0117755 A1
(43) Pub. Date: May 17, 2012

(54) Door Closer

(75) Inventor: Oliver Walhorn, Werther (DE)

(73) Assignee: DORMA GMBH + CO. KG, Ennepetal (DE)

(21) Appl. No.: 13/386,877

(22) PCT Filed: Jul. 15, 2010
(86) PCT No.: PCT/EP2010/004304

§ 371 Date: Jan. 24, 2012

(30) Foreign Application Priority Data
Jul. 24, 2009 (DE) 10 2009 034 742.9

(51) Int. Cl. E05F 3/10; E05F 3/20

(52) U.S. Cl. 16/66; 16/50

(57) ABSTRACT

A door closer including a rotating shaft coupled to a door leaf, including a cam disposed on the rotating shaft in a torque-proof manner and cooperates with a spring-loaded roller, such that, when opening or closing the door leaf, the roller rolls on a first running surface of the cam, and in that a second running surface of the cam cooperates with a damping device. The damping device consists of at least one pre-mounted damper which is self-contained and is insertable into the door closer.

### CROSS REFERENCE TO RELATED APPLICATION

This is a U.S. national stage of application No. PCT/EP2010/004304, filed on 15 Jul. 2010. Priority is claimed on German, Application No. 10 2009 034 742.9, filed 24 Jul. 2009, the content of which is incorporated here by reference.

### BACKGROUND OF THE INVENTION

1. Field of the Invention

The invention relates to a door closer including a rotating shaft coupled to a door leaf and a cam, which is disposed in a torque-proof manner on the rotating shaft and cooperates with a spring-loaded roller, such that, when opening or closing the door leaf, the roller rolls on a running surface of the cam.

2. Detailed Description of Prior Art

The document DE 9209276 U1 describes a door closer including a damping device. This damping device affects the opening and closing behavior of the swing leaf door and acts upon the cam disc located on the opposite side of the spring-loaded pressure roller. This damper is configured as a hydraulic piston-cylinder unit in which an oil volume is displaced between several pressure compartments via channels and valves. The channels and valves are disposed within the door closer housing which, from the manufacturing point of view, is very expensive.

These dampers are disadvantageous in that, when the hydraulic fluid is soiled, the damping function may be disrupted because the narrow valves and hydraulic channels may clog. As the entire damping area is filled with hydraulic fluid, another disadvantage is that leaks may occur in the event of malfunction, which may result in dripping of the door closer, which is very unpleasant for the user of the door. This type of damper is very expensive from the manufacturing point of view, because manufacturing is costly. An exchange or modification of the damper likewise requires uninstalling the entire door closer, which is very expensive, because at least the damping area, and depending on the type of construction of the door closer, the entire door closer needs to be refilled with oil.

### SUMMARY OF THE INVENTION

It is an object of one embodiment of the invention to provide a door closer that does not have these disadvantages.

According to one embodiment of the invention, a pre-fabricated and self-contained damper is inserted into the door closer. The pre-fabricated damper results in simple mounting and exchangeability. As the dampers are self-contained, the door closer does not have to be filled with oil in the area of the damper. Leaks are avoided. Also, the expensive manufacturing of the housing with incorporated channels and valves is no longer required. Therefore, the door closer is operating in a more reliable manner and is more service-friendly.

The damper damps the rotational movement of the door by consuming kinetic energy, wherein, in the preferred embodiment, the damper has a piston, which moves a fluid or a gas between two pressure compartments in a cylinder. Thereby a very small and effective damper can be provided which, on account of its structural dimension, is easy to incorporate into the dimensions of a door closer.

It is particularly advantageous, if the damper corresponds with an abutment, which in turn cooperates with the cam. In this case, the damper is pre-mounted with the abutment and can be inserted into the door closer as a finished structural component. The abutment may present a flat, convex or concave abutment surface, wherein the configuration of the abutment surface may in turn increase or reduce the eccentricity. An additional variable is thus available with the configuration of the abutment surface, in order to combine a door closer with different dampers, respectively damper cartridges for different applications.

It is furthermore advantageous, if several dampers are mounted together with the abutment, because the damping force can be affected by the amount of dampers.

The disposition of the one or more dampers within a damper reception, which together with the abutment constitutes the damper cartridge, allows for easy exchangeability of this structural component. Furthermore, according to the desired damping effect, the damper cartridge may be adapted and equipped with one or more dampers. The mechanic installer or final user has the advantage that neither special tools nor expert knowledge are required to exchange a damaged damper or to adapt the system to the given circumstances with a higher damping effect.

In a preferred embodiment, the dampers are configured as closing dampers, which consume the kinetic energy upon compression. A counter-force is applied for this purpose such that the abutment is permanently pressed against the cam. In this case, an inexpensive option is to equip the damper cartridge with a compression spring, which presses the abutment against the cam. It is thereby assured that the abutment and the cam are in permanent contact.

Another embodiment of the invention provides that the damper effect be produced by an eddy-current brake or a hysteresis brake.

In a preferred embodiment, within the cylinder, the piston may move gas or fluid between the two pressure compartments. Thus, small and standardized structural components can be utilized, which are inexpensive, easy to exchange and can be combined with each other to provide different damping power. The damper is thus self-contained, because all the structural components relevant for the damping function are incorporated within the damper. No leakages at the door closer will occur with the aforementioned embodiment. Blocked valves and blocked hydraulic lines will no longer occur, because they are not required for the damping function. And in case of re-mounting, the door closer does not have to be filled with oil either.

In one embodiment an overload protection is disposed at the abutment. Damage or destruction of the dampers is thereby avoided. In a preferred embodiment, the overload protection is configured as a leaf-spring, which deforms at too important forces.

### BRIEF DESCRIPTION OF THE DRAWINGS

In the following, further advantages and embodiments of the invention will be explained in detail based on several possible diagrammatically illustrated embodiments. In this case, the same reference numerals are utilized for the same structural components.

In the drawings:

FIG. 1: is a perspective illustration of a door closer,

FIG. 2: is another perspective illustration of the door closer,

FIG. 3: is a perspective view of a damper cartridge.

### DETAILED DESCRIPTION OF THE PREFERRED EMBODIMENTS

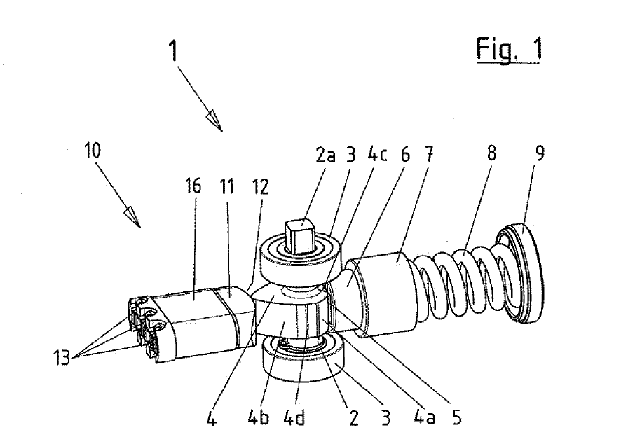

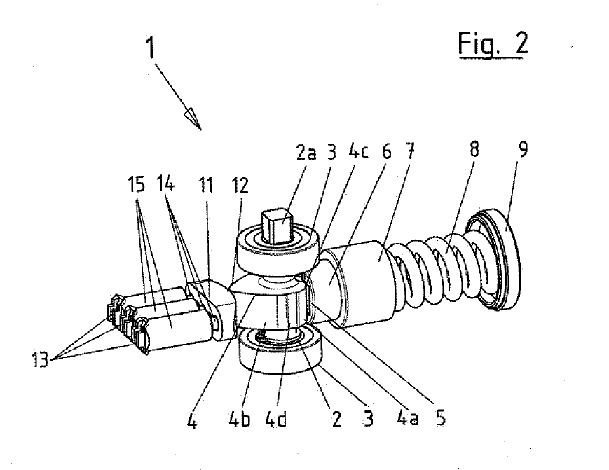

A door closer 1 is illustrated in FIGS. 1 and 2, wherein the housing is not shown for the purpose of more clarity. This door closer 1 may be fastened to a non-illustrated door leaf. In this case, one end of the actuating arm is fastened to a pivot 2a of a rotating shaft 2, wherein the other end of the actuating arm, via a sliding block, engages in a guiding rail disposed at the door casing. Furthermore, the reversed installation is possible in which the door closer 1 is mounted to the door casing and the slide channel to the door leaf. Upon opening the door, the rotating shaft 2 rotates such that the cam 4 compresses the spring 8 via the roller 5, the roller piston 6 and the adjusting cylinder 7. If the user releases the door, the spring 8 presses indirectly against the roller 5, which rolls on the cam 4 on the first running surface 4a, and thus returns the rotating shaft 2, back into the initial position.

All illustrated structural components are installed in one housing made from metal or plastic material, which, in the longitudinal axis, has a bore for the one or more dampers 13, the cam 4, the roller 5, the roller piston 6, the adjusting cylinder 7 and the spring 8. Transverse to this bore, the housing has a second bore, which essentially receives the rotating shaft 2 with the bearings 3. The cam 4 is disposed at the intersection of the bores. On the one hand, the spring 8 bears against the closure 9, which, at the same time, closes off the oblong bore through the door closer, and on the other hand, it bears against the adjusting cylinder 7, which is disposed to be axially displaceable within this bore.

The cam 4 is connected to or disposed on the rotating shaft 2 in a torque-proof manner. The rotating shaft 2 is supported within the door closer housing by two bearings 3. A pivot 2a is disposed at one end of the rotating shaft 2, outside the bearing 3, which pivot protrudes from the housing and receives an end of an arm assembly, the other end thereof cooperating for example with a slide channel. The cam 4 has a first and a second running surface 4a, 4b. The first running surface 4a is configured in that a decreasing torque is generated at the door. This means, the door is opened with a higher force and during the further opening operation, the required force decreases. The second running surface 4b corresponds with an abutment surface 12, such that, during the closing procedure of the door, the door is closed to be damped according to a desired travel profile. The running surfaces 4a, 4b may be disposed symmetrically or non-symmetrically on the cam. In the above embodiments, the cam 4 and therefore the door closer 1 are configured as double-action door closer.

In the zero position of the door, the roller 5 is located in a depression 4c of the cam 4. Upon opening the door, the rotating shaft 2 rotates together with the cam 4, such that the roller 5 rolls on the first running surface 4a of the cam. In this case, the roller 5, together with the roller piston 6 and the adjusting cylinder 7, is pressed against the spring 8 and exits the depression 4c during this rotary movement. Another recess 4d may be disposed at a 90° angle with regard to the depression 4c, such that the door stops at this intermediate position. This one recess or a plurality of recesses 4d may be disposed and distributed in an arbitrary way on the circumference of the cam 4, depending on the intermediate positions, in which the door is supposed to stay open. If the door is closed with momentum, the rotating shaft 2 rotates with the cam 4, until the roller 5 reaches the depression 4c again. In this case, depending on the size of the spring force, the cam 4 with the depression 4c swings back and forth several times, wherein, in this case, the roller 5 passes the depression 4c of the cam 4, until the momentum of the spring force and the force of the damper 13 is more important than the remaining torque of the door.

Damping the door movement is realized by at least one damper 13, which comprises at least one piston 14 and a cylinder 15. One end of the piston 14 is fastened to an abutment 11, the abutment surface 12 thereof corresponding with the second running surface 4b of the cam 4. The dampers 13 are configured as pre-mounted units, which, as an assembly, are inserted into an opening of the door closer housing. In this case, the pre-mounted units may be configured to be graduated according to different damping strengths. In this case, the dampers 13 are self-contained, such that the damping medium or the damping mechanism is integral with the damper 13.

The one or more dampers 13, according to this first embodiment according to FIG. 1, is/are disposed in a damper cartridge 10, which has a damper reception 16 and an abutment 11 with an abutment surface 12, wherein the abutment surface 12 cooperates with the cam 4. The damper reception 16 may receive at least one or more dampers 13, wherein, in a preferred embodiment, the cylinders 15 of the dampers 13 are coated with plastic material or encased therein. The abutment 11 is connected to the pistons 14 of the dampers 13. The abutment 11 may have a flat, convex or concave abutment surface 12, which cooperates with the second running surface 4b of the cam 4. In this case, the geometry of the abutment surface 12 depends on the desired damping effect. As the dampers 13 function as closing dampers, the abutment 11 needs to be pressed against the cam 4 against the damping force. This is accomplished by means of one or more springs 17, which press the abutment surface 12 against the second running surface 4b of the cam 4.

Mounting/dismounting the damper cartridge 10 is realized in that a non-illustrated closure, which is disposed at the frontal side of the door closer housing, is opened respectively closed, such as to be able to completely insert the damper cartridge 10. Unlike in the prior-art, in this case, no oil is drained from the door closer 1, because the damping medium, in case of a hydraulic or pneumatic damper 13, is encapsulated within the individual dampers 13. Likewise, soiling or clogging the hydraulic lines and valves is no longer possible. Just as no leakage will occur any more, which would be very unpleasant for the user of the door.

In the second embodiment according to FIG. 2, at least one damper 13 is disposed within the door closer 1, and comprises a piston 14 and a cylinder 15. In this embodiment, three dampers 13 are disposed next to each other, the pistons 14 thereof being connected to the abutment 11. In this case again, mounting/dismounting the dampers 13 is realized in that a non-illustrated closure, which is disposed at the frontal side of the door closer housing, is opened respectively closed, such as to be able to completely insert the one or more dampers 13 which are completely pre-mounted with the abutment 11. In this embodiment, unlike in the prior-art, in this case, no oil can leak from the door closer 1, because the damping medium, in case of a hydraulic or pneumatic damper 13, is encapsulated within the individual dampers 13. Therefore, soiling or clogging the hydraulic lines and valves is no longer possible. Just as no leakage will occur any more, which would be very unpleasant for the user of the door.

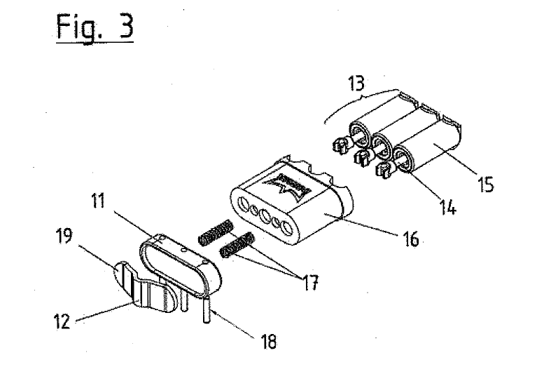

The disposition of the dampers 13 in a damper cartridge 10 is illustrated again in FIG. 3. In this embodiment, three dampers 13 are illustrated together with their pistons 14 and cylinders 15, which are inserted into a damper reception 16. The connection between the abutment 11 and the dampers 13 is realized via pins 18. Springs 17, which allow the pistons 14 to travel out of the cylinders 15, are disposed between the abutment 11 and the damper reception 16. In this embodiment, an overload protection 19 is disposed at the front side on the abutment 11, the abutment surface 12 thereof cooperating with the cam 4. The overload protection 19 prevents the dampers 13 from being destroyed should the door be operated at too high a momentum. The overload protection 19 is configured in this embodiment as a leaf spring, which deforms at overload.

The disposition of the one or more dampers 13 in a damper cartridge 10 is advantageous in that the dampers can be exchanged as a module without requiring major mounting and adjusting work. Furthermore, the damper cartridges 10 may be combined, depending on the desired application and damping effect, wherein for example only one damper cartridge 10, with one or two dampers 13, will be used for low damping, and a damper cartridge 10, with for example three or four dampers 13, will be used for a larger damping effect.

The damper 13 may be equipped with an opening and/or damping function, which effects a speed reduction in one of the terminal positions. For this purpose and depending on the application case, the damper 13 may be provided with an air or oil damping, may have an eddy-current brake or a hysteresis brake.

In a preferred embodiment, the dampers 13 are configured as closing dampers such that, the door is damped when being moved into the zero position, respectively when being closed. For this purpose, the dampers 13 are configured in that only little force needs to be deployed when the piston 14 travels out of the cylinder 15. When closing the door, the pistons 14 travel back into the cylinder 15 and produce an important force such that the door is damped in the zero position, respectively when being closed. It is thereby guaranteed that with a normal door, which moves against an abutment or a seal, the door can not be damaged. A double-action door is thereby prevented from opening at great momentum in the opposite direction and to swing back and forth. In this preferred embodiment, the dampers 13 are filled with a fluid or with gas which, when the damper 13 is actuated, moves back and forth between two pressure compartments. When utilizing valves or particularly configured seals, it is achieved—in this case when pulling the piston 14 out of the cylinder 15—that the fluid or the gas is displaced at low resistance in only one direction between the pressure compartments, whereas a large resistance is generated in the other direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A door closer comprising:
a damping device having at least one self-contained pre-mounted damper that is insertable into the door closer
a spring-loaded roller;
a rotating shaft coupled to a door leaf; and
a cam disposed on the rotating shaft in a torque-proof manner that cooperates with the spring-loaded roller, such that, when opening or closing the door leaf, the spring-loaded roller rolls on a first running surface of the cam and in that a second running surface of the cam cooperates with the damping device.

15. The door closer according to claim 14, wherein the pre-mounted damper comprises a piston and a cylinder.

16. The door closer according to claim 15, wherein the piston is connected to an abutment, the abutment surface corresponding to the second running surface.

17. The door closer according to claim 16, wherein the abutment cooperates with a plurality of pre-mounted dampers.

18. The door closer according to claim 14, wherein at least one pre-mounted damper is disposed in a damper reception.

19. The door closer according to claim 18, wherein the damper reception including at least one pre-mounted damper together with its respective abutment form a damper cartridge.

20. The door closer according to claim 16, wherein the abutment surface is configured to be one of flat, convex, and concave.

21. The door closer according to claim 14, wherein the at least one pre-mounted damper is a closing damper.

22. The door closer according to claim 21, wherein the damper cartridge has a spring that presses the abutment against the cam.

23. The door closer according to claim 14, wherein the damper has one of an eddy-current brake and a hysteresis brake.

24. The door closer according to claim 15, wherein, within the cylinder, the piston moves one of a fluid and a gas between two pressure compartments.

25. The door closer according to claim 16, further comprising an overload protection is disposed at the abutment.

26. The door closer according to claim 25, wherein the overload protection is a leaf spring.
